(19) United States
(12) Patent Application Publication
(10) Pub. No.: US 2013/0252223 A1
(43) Pub. Date: Sep. 26, 2013

(54) SYSTEM AND METHOD FOR INCULCATING EXPLORATIVE AND EXPERIMENTAL LEARNING SKILLS AT GEOGRAPHICALLY APART LOCATIONS

(71) Applicant: Srikanth Jadcherla, Hyderabad (IN)

(72) Inventor: Srikanth Jadcherla, Hyderabad (IN)

(21) Appl. No.: 13/989,065

(22) PCT Filed: Jul. 27, 2011
(86) PCT No.: PCT/IN11/00497

§ 371 Date: May 23, 2013

(30) Foreign Application Priority Data
Nov. 23, 2010 (IN) 3509/CHE/2010

(51) Int. Cl. G09B 7/00

(52) U.S. Cl. CPC G09B 7/00
USPC 434/350

(57) ABSTRACT

The present invention relates to a system and method for enhancing innovative abilities by providing quality education and practical skills to the students and inculcating explorative and experimental learning skills in the students located at geographically apart locations comprising an administrative body 200, at least one adjustable classroom in at least one college or study centre 201, at least one interaction terminal 11, means for online interactive communication, means for offline communication, local server 40, at least one expert instructor 12, at least one student 100 at geographically apart location, at least one local coordinator 13, support means, forum for continuous support and assessment means. The method of instruction in the invention provides a more practical approach to learning the subject and prepares the students to effectively meet the technical skill requirements of the industry.

### FIELD OF INVENTION

The invention relates to a system and method for inculcating explorative and experimental learning skills in students at geographically remote locations. More particularly, the invention relates to a system and method for enhancing innovative abilities by providing quality education and practical skills to the students and inculcating explorative and experimental learning skills in the students located at geographically apart locations. The invention further relates to an educational system which is not restricted by the geographical location of the student or the instructor. The method of instruction in the invention provides a more practical approach to learning the subject and prepares the students to effectively meet the technical skill requirements of the industry.

### BACKGROUND

Level of economic development of a country depends on its level of human resources development in various fields like science, engineering, medicine, math, arts, humanities, law as well as technological advancement and industrialization in the country. Lack of appropriate practical skill acquisition in various educational streams and proper industry employable training had been a subject of concern in India as well as other developing nations.

Typically, education in India and other developing countries lack coordination in curriculum development and dissemination between the institutions, industries and students. The curriculum is not structured to meet the changing trends in economy, science, medicine, technology, legal and social parameters etc. There is no direct relationship and interaction between industries and institutions in research activities and manufacturing.

Excellence in employable education comes from innovative teaching techniques and effective instructional materials. The present education system in India and other developing nations is largely theory oriented without sufficient emphasis on improvement of innovative thinking of the students. In the traditional teaching methods, lecturers offer course material in a classroom or online, where students listen, take notes, copy materials, execute home works and complete assignments. In many cases teachers fail to transfer knowledge to students effectively despite personally having sound technical, industrial and employable knowledge in the subject area. Most industries complaint stem from inadequate skills for most cutting edge technologies and changing economies, low practical knowledge and lack of confidence in the passing out students. Lack of practical assignments and projects in the emerging technologies set a drawback to the quality of education, more particularly, engineering education and the graduate. Most of the science, engineering, management and law graduates are tend to subjected to several training programs, since most of the graduates are considered non-employable going by the quality of training and skills acquired from their various institutions.

Generally, teachers in colleges and educational institutes may also lack the required knowledge, skill and technique to provide the quality education. This shortfall of qualified faculties in the emerging fields forces the institutions to award theoretical knowledge oriented degrees to the students that prove to be a major setback to the student's candidature, which fails to meet the industry requirements. The reason behind this lack of required teaching knowledge and skill is that faculty training on new teaching methods is not done periodically and teachers still follow archaic teaching methods. This hampers the improvement in the overall educational system. The lack of adequate employable knowledge and skills also results from the fact that average students generally do not have fruitful discussions and question-answer sessions with the faculty members.

Conventionally, live teaching is very widely practiced in the Indian Education System and similar developing nations. Therefore, quality of education also depends on the geographical location of the student and the teacher. This means that the availability/utilization of an expert's instruction is severely restricted in geographical spread and in time when associated to a group of students. Remote areas also have severe problem of attracting and retaining qualified teachers. Even in areas where an instructor can deliver a remote lecture or students can view a recorded audio visual lecture, post lecture follow-up is quite difficult to accomplish. Practical learning always needs an ongoing support and interaction mechanism which leads right back to the problem of trained faculty.

Live teaching also makes it difficult to train faculty on a daily basis. Cost of travel and time involved in making new curriculum makes it very difficult to proliferate.

Students in rural places generally have less or no access to the expert instructors in many subject domains than their counterparts in urban places. Most of the educational institutes in rural areas have shortage of qualified faculty members and proper laboratory facilities.

The exam pattern forces the students to memorize as many things as possible and it becomes another reason for poor quality graduates. Students are judged on their capacity to remember the concepts rather than their ability to apply their knowledge on practical issues.

The curriculum is generally not revised at par with the advancements in the economy, technology and requirements of the industry which results in graduates with minimum exposure to the latest technical, economic, management and legal advancements and skills used in the industry. Even the process of updating curriculum does not appear to have any collaborative feedback mechanism of gathering inputs from students, teachers and industry experts.

Since students have very little or no interaction with the industry leaders therefore, students graduating from the institutes and looking for job opportunities in industry lack the required knowledge and skills about the latest technology developments, management skills, legal aptitude, economic advancements, IT advancements and the requirements of the industry.

Though India has made a giant leap in the fields of telecommunication, medical science and technology, these advancements are underutilized failing to provide the educational requirements using ‘remote teaching’ facilities or online knowledge sharing.

All these factors result in poorly qualified graduates, making it necessary for the companies to give extensive technical training to the newly employed graduates. This costs the companies both in time and in money and slows down the growth process of the employer in the competitive market and of the employee in his/her career ladder, as compared to their global counterparts.

Various efforts have been made in the prior art to overcome the problems discussed above. Some of the relevant prior arts can be summarized in the proceeding published documents.

U.S. Pat. No. 5,437,555 discloses a computerized teaching system consisting of an interactive group communication system, wherein students interact with a teacher and the teacher can obtain quantitative reports on student performance without preprogrammed lessons and where a lesson program can be constructed from the responses of the students. The teaching system may be spread over a large geographic area comprising a multiplicity of learning centers with a multiplicity of students at each center, wherein the students interact with a teacher who is remotely located from one or more learning centers.

U.S. Pat. No. 4,785,472 discloses a remote teaching system which includes a teacher station and a plurality of student stations which may be located at sites remote from one another. Each station includes a speaker telephone or other voice telephone set which is connectable to a telephone system for voice communication among the various stations. Each station includes a video display monitor such as a television set and a video media player such as a video-tape cassette player connected to the video display monitor. Each student station also includes a video-media-player controller which is connected to the video media player of the student station for controlling the playing of the player. The teacher station includes a video-media-player master controller connected to the video media player of the teacher station for controlling the playing of the player. The video-media-player master controller of the teacher station and the video-media-player controller of the student stations are connectable to the telephone system for transmitting and receiving telephonic control signals over the telephone system, so that the playing of the video media player of the teacher station and the video media players of the student stations can be synchronized.

US 20080090219 discloses a method for teaching a practical skill to a plurality of learners at geographically separate locations and includes receiving, for each learner, a video feed generated by a camera at the learner's location. The video feed depicts at least a subject on which the learner is demonstrating the practical skill. The teacher simultaneously displays the video feeds for the plurality of learners on a display screen at a location of the teacher. One or more learners are allowed to submit questions to the teacher that are not immediately conveyed to the other learners. The teacher is allowed to select one of the learners having a question for individualized instruction, and to establish a private communication channel between the teacher and the select.

Indian Patent No. 196490 discloses a method of disseminating teaching instructions comprising the steps of providing teaching instruction generating laboratory adapted to download information from the internet cloud via at least one high band width internet pipe, generating and creating teaching instructions, cross linking the downloaded information with the generated and created teaching instruction, storing the cross linked downloaded information and the generated and created teaching instructions, transmitting selectively and in a controlled manner the stored cross linked downloaded information and the generated and created teaching instructions to a plurality of remotely situated nodes and receiving feedback and updated information from the nodes for generating further teaching instructions at the teaching instruction generating laboratory.

Indian Patent No. 230961 discloses an evaluation based learning system (EBLS) which is used by authors, teachers, students and education administrators for the development of courses, the teaching of courses, the studying of courses and the administration of information and data relevant to the courses. The EBLS provides an efficient authoring, teaching and learning environment wherein a database of questions and answers are linked to a textbook to facilitate the learning and evaluation process of students studying a textbook.

U.S. Pat. No. 7,698,360 discloses a system and method for distance learning that can be used to teach a typical IT training course. In one aspect, a student that desires to perform remotely an exercise from an IT training course uses his/her Java-capable browser to connect to a distance learning web server. The web server downloads to the browser a list of exercises that the student can choose from. After the student selects an exercise, the web server launches the virtual machines that are needed for the student to perform the selected exercise. The virtual machines are launched on a computer system that is remote from the student, but the computer system includes a remote display server. After the virtual machines are launched on the remote system, a remote display viewer is loaded in the student's browser and the remote display viewer connects to the remote display server. After the viewer connects to the remote display server, the viewer displays one or more of the virtual machines in a window on the student's computer. Thus, after the viewer connects to the remote display server, the student can remotely interact with the virtual machines that are required for the student to perform the exercise.

U.S. Pat. No. 5,850,250 describe a video distance learning system including a teaching classroom connected to remote learning classrooms by a fiber-optic communication network. The teaching classroom includes at least a rear audio/video cabinet housing four video monitors and a camera. The remote classrooms have front cabinets with four monitors and a camera. In a normal operating mode, one of the video monitors will display the teacher, while the other three monitors display classroom images. A rear video camera mounted is focused on the teacher and a front video camera may be focused on the students. The front video cabinet may have a graphics or document camera is also provided on the front video cabinet. The document camera points downward at a light table to image materials such as books, pictures and overhead transparencies. The teacher may switch between the rear camera, the front camera and the document camera. A teacher's workstation may be located at the front of the teaching classroom. A control panel allows the teacher to control all devices located within the room, such as volume, displays, or focus. The work station may also include a personal computer interfacing with the network to schedule classes. The video distance learning system facilitates eye contact between the teacher in a teaching classroom and students in remote classrooms.

U.S. Pat. No. 7,467,947 the disclosure in this patent includes course catalogue updates. In one embodiment, a method includes identifying a course type in an internal course catalogue. The internal course catalogue is associated with a local learning management system. A request for a course that is associated with the course type and referenced in a remote course catalogue is automatically transmitted to a remote learning management system. The remote learning management system is operable to provide a plurality of courses. Information associated with the course is received from the remote learning management system. The course is automatically generated in the internal course catalogue using the received information.

U.S. Pat. No. 5,295,836 entitled “remote lecturing system comprising first storage means for storing contents of a at least one lecture of a lecturer, second storage means for storing questions and corresponding answers related to each lecture stored in said first storage means. Reproducing means, coupled to said first storage means, for retrieving from said first storage means the contents of an arbitrary lecture which is requested in response to an external request from a first terminal station which is operated by a student at an arbitrary time, and for transferring the retrieved contents to the first terminal station, answer obtaining means, coupled to said second storage means, for retrieving from said second answer obtaining means interrupting the transfer of the contents of the arbitrary lecture from said reproducing means to the first terminal station when the question is raised from the first terminal station and a communication network coupled to a plurality of terminal stations, said reproducing means and said answer obtaining means being coupled to the first terminal station by way of said communication network, said reproducing means broadcasting the arbitrary lecture to the terminal stations coupled to said communication network, and said answer obtaining means broadcasting the question and the corresponding answer to the terminal stations coupled to said communication network.

However, various efforts in the direction made in the past have not been able to overcome the problem of poorly skilled students graduating from various institutes therefore, making it necessary for the companies to spend money and time for extensive training programs for the newly employed graduates.

### OBJECTS OF THE INVENTION

The primary object of the invention is to provide a system for inculcating explorative and experimental learning skills in students at geographically apart locations.

Another object of the invention is to provide a system for imparting quality education and practical skills in non co-located students.

Another object of the invention is to provide a practical approach to learning subject and preparing the students to effectively meet the technical skill requirements of the industry.

Another object of the invention is to provide a method of inculcating explorative and experimental learning skills in students at geographically apart locations.

Another object of the invention is to provide a method of providing quality education and practical skills to the students at geographically apart locations.

A further object of the invention is to produce highly skilled graduates who can meet the requirements of the industry

### SUMMARY OF THE INVENTION

The present invention discloses a system and method of providing quality education and practical skills to students of diverse educational streams like science, arts, medicine, engineering, technology, economics, law, management, humanities, social and general studies etc and inculcating explorative and experimental skills in students located at geographically apart locations. The present system and method is not restricted by the geographical location of the instructor or the students and enhances the employable skills of the students resulting into highly skilled graduates who can meet the industry requirements.

The invention comprises a Global Class Room (GCR) and interaction terminal setup in a college or study centre. The college may be selected from any private or Government run college managed by its own administrative staff whereas, study centre may be generally managed by an administrative body. The GCR and interaction terminal are meant to receive the lecturers delivered by the remotely located expert instructor. The interaction terminal comprises computers, video projectors, projector screens, webinar and VOIP internet tools, audio installation and backup teleconference. The expert instructor delivers his lecture from a remote location for non co-located students. Local co-ordinator at college or study centre manages the lecture sessions, monitors proper functioning of the audio-video equipments, assists the students during lecture and liaison between the college or study centre and the administrative body. The local co-ordinator may be one or more individual selected from the group of a local faculty member having knowledge in the subject domain, support instructor and technical assistant. Expert instructor and students also have live interactions through web based services like webinar, VOIP internet, worldwide web or multimedia enabled mobile phones.

After the online classes, a set of explorative assignments and projects are given to the students for practice along with the necessary computer equipments required for enabling the students to get connected to remote access labs to work on their coursework. A continuous assistance and support to the students is provided through online social networking methods, through local coordinators, library and other online/offline resources. Students can complete the assignments and projects with the assistance of all or any of the supporting means and create solution files in response to the course assignments and projects and transfer them online to the server computer or can submit them offline and in hardcopies.

Student's progress is evaluated and graded by the expert instructor based on their performance in the assignments and projects and same is posted on the server computer of the administrative body which is accessible only to the student or relevant personnel of the institution. Skill matrix of the students is tabulated to depict the level of achievement of the student in each subject before and after attending the course.

### STATEMENT OF INVENTION

Accordingly the invention provides a system for inculcating explorative and experimental learning skills in students at geographically apart locations comprising of an administrative body 200, at least one adjustable classroom in at least one college or study centre 201, at least one interaction terminal 11, means for online interactive communication, means for offline communication, local server 40, at least one expert instructor 12, at least one student 100 at geographically apart location, at least one local coordinator 13, support means, forum for continuous support and assessment means.

There is also provided a method of inculcating explorative and experimental learning skills in students at geographically apart locations comprising of establishing at least one interaction terminal 11 and classroom in a college or study centre 201, receiving lecture in at least one subject by remotely located expert instructor 12 for non co-located students 100 at interaction terminal 11, receiving at the interaction terminal 11 the course files, course lectures, textbooks, literature, assignments, projects, student FAQ and other course materials transmitted by the expert instructor 12, establishing live interaction sessions 22 between expert instructor 12 and the students 100, expert instructors 12 preparing explorative assignments and projects and assigning it to the students 100, recording and storing lectures on local server 40 at administrative body, providing unique user id and password to students to access the local server 40, allowing students to get connected to remote access labs and providing full assistance to the students 100 to complete the assignments and projects, transferring the solution files created by the students 100 to the local server 40 or to the administrative body, accessing the files on server or at administrative body and expert instructors evaluating and accessing the student's progress; making the grades available to the student 100 and relevant institution personnel, tabulating the skill matrix and depicting the level of achievement of student before and after the course; providing the relevant statistics/metrics on student performance, tools' usage and coding quality to the concerned college 201.

### BRIEF DESCRIPTION OF THE DRAWINGS

FIG. 1 illustrates a flow chart diagram describing the steps involved in the method of invention;

FIG. 2 illustrates a pictorial representation of the system of the present invention;

FIG. 3 illustrates a diagrammatic representation of the architecture of the education system;

FIG. 4 illustrates a diagrammatic representation of different steps involved in the method; and

FIG. 5 illustrates a tabular representation of the skill matrix in different examples.

### DETAILED DESCRIPTION OF THE DRAWINGS

Detailed embodiments of the present invention are disclosed herein with reference to the drawings. However, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting but rather to provide an understandable description of the invention.

The invention discloses a system and method of inculcating explorative and experimental learning skills in students at geographically remote locations. More particularly, the invention discloses a system and method of providing quality education and practical skills to students located at geographically apart locations, in diverse education streams like science, arts, medicine, engineering, technology, economics, law, humanities, management, social and general studies etc. The invention also discloses an educational system which is not restricted by the geographical location of the student or the instructor and enhances the employable skills of the students resulting into highly skilled graduates who can meet the industry requirements.

The method of instruction in the invention provides a more practical approach towards learning the subjects and prepares the students to effectively meet the technical skill requirements of the industry.

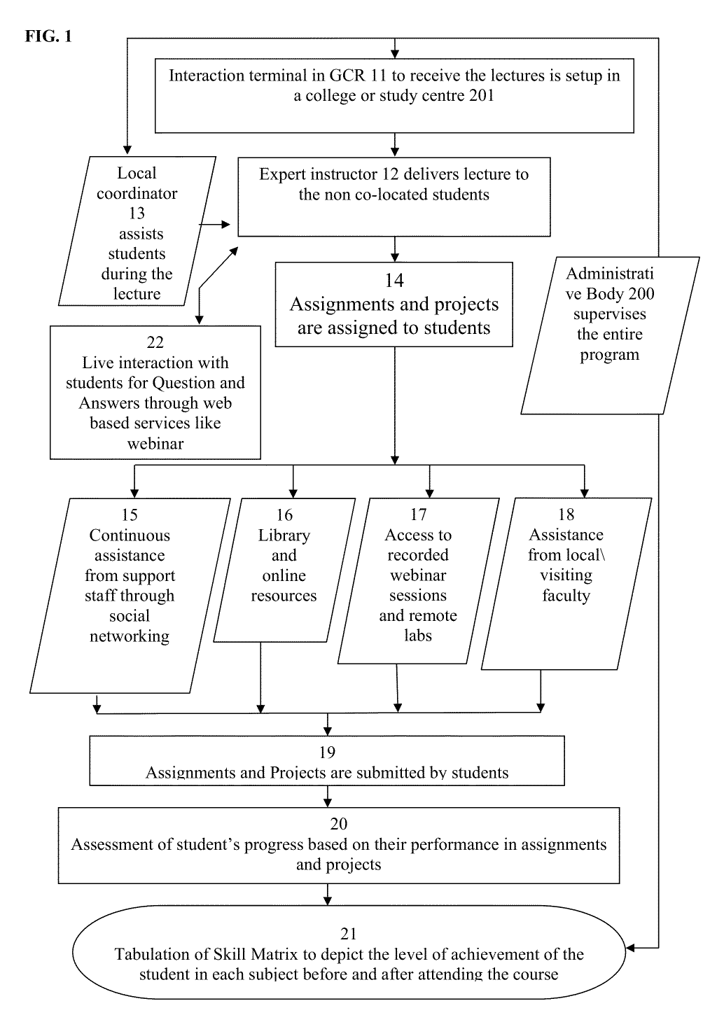

Referring to FIG. 1, a Global Class Room (GCR) and interaction terminal 11 is setup in a college or study centre 201. The college may be selected from any educational institution whereas study centre 201 may be generally managed by an administrative body 200. The GCR and interaction terminal 11 are meant to receive the lectures being delivered by the remotely located expert instructor 12 who delivers the lecture to the non co-located students 100. Multiple numbers of GCR and interaction terminal 11 may be established in multiple numbers of colleges or study centres at multiple geographical locations. The multiple numbers of interaction terminals may be set up simultaneously or consecutively depending upon the number and geographical location of the students participating in a course. The GCR 11 comprises interaction terminal and seating arrangements. In one of the embodiment of the invention, GCRs 11 also includes laboratories for engineering and other technical courses. The interaction terminal comprises computers 30 with devices synchronized to receive the user specific and password protected audio and video signals comprising instructions and lectures relayed from the local server 40 at administrative body 200 and converting said signals into text, audio and video files and displaying those texts and videos on the projector screen and enabling the audio files audible through audio installation at the interaction terminal The interaction terminal also comprises video projector, projector screen, webinar and VOIP internet tools, audio installation, backup teleconference, power supply and related accessories needed for establishing interactive communication between students 100 and expert instructor 12. The communication between students 100 and expert instructor 12 is established via interactive webinar and VOIP internet tools along with backup teleconference for audio. Audio installation and bandwidth of the internet connection is periodically checked before each class to confirm a distortion free signal. Video can be availed with access to high bandwidth internet connection. The interactive terminal is well equipped with means to survive the power and network outages and also backups to manage low bandwidth internet connections. In preferred embodiment of the invention, internet VOIP tool is used as primary channel to establish the interactive communication between students 100 and the expert instructor 12 in interaction terminal 11. However, the communication means can be switched from internet VOIP tool to teleconferencing tool if internet bandwidth is not sufficient to establish a distortion free interactive communication. Therefore, in preferred embodiment the primary channel for communication between students 100 and expert instructor 12 is webinar and internet VOIP tool. Whereas, secondary channel of teleconference tool is provided as backup tool which is used when there is a drop in internet bandwidth to a measure which is not enough to provide a distortion free communication. Size of the GCR 11 may be determined according to the number of students in the class. The method of having an interactive educational session is established by Audio-Video distribution bridge that distributes the live lectures from the expert instructor to the GCR through the internet, which is further distributed to the students by the well equipped interactive terminal Only one internet source connection is used for one GCR according to the present invention. Various components of the interaction terminal like video projector, projector screen and audio installation are adjusted according to the size of classroom to provide a satisfactory bridging between students 100 in GCR 11 and expert instructor 12.

The classroom receives the lectures from expert instructor 12 via communication means established at the interaction terminal 11. Lecture from expert instructor 12 can be received at interaction terminal in the GCR 11 in any educational stream selected from science, arts, medicine, engineering, technology, economics, humanities, culture, law, and management, social and general studies among others. In one embodiment of the invention, the lecture is received in engineering and technology streams. The expert instructor 12 can deliver the lecture on any subject selected from science, arts, medicine, engineering, technology, economics, culture, law, management, social and general studies or any other educational stream. An expert instructor 12 is one who is a well referenced person in his/her subject domain like a professor; a very experienced person whose knowledge in his/her field is very valuable in the market like an experienced professional and a person who is in the cutting edge research or practice in his/her subject domain like a scientist.

The expert instructor 12 is selected from diverse educational streams selected from science, arts, medicine, engineering, technology, economics, culture, law, management, humanities, social and general studies, depending upon the requirement of the students. The expert instructor 12 can also transmit the course files including course lectures, textbooks, literature, assignments and projects and other course materials, students FAQ using online and offline electronic network such as the Internet or Worldwide Web or the communication means established at the interaction terminal 11 and various social networking means messaging, twitter and blogs.

The college or study centre 201 has a local co-ordinator 13 who manages lecture sessions, monitors and controls proper functioning of the audio-video equipments, assists the students during the lecture and liaison between the college or study centre and administrative body 200 and is a contact point of administrative body in college or study centre. The local co-ordinator may be one or more individual selected from the group of a local faculty member having knowledge in the subject domain, support instructor and technical assistant. The local coordinator 13 assists the students 100 during the online lecture from expert instructor 12 and provides first line support to students in understanding the lecture contents.

Expert instructor 12 also has, in addition to delivering lectures, live interaction sessions 22 with students 100 for question and answers established through web based services like webinar, internet, worldwide web or multimedia enabled mobile phones. Students 100 can interact live with the expert instructor 12 via online texting facility like chat room. An online and offline forum to ask questions and receive answers is always available. Social networking web communication means like messaging, twitter and blogs are used for online/offline interaction between expert instructor 15 and students 100. The battery of hosts/teaching assistants helps the expert instructor 12 in answering the questions by the students 100 during their lectures, assignments & projects. The support means including local coordinators and teaching assistants are available to the students for onsite and remote assistance through internet, screen sharing, virtual network computing (VNC) and multimedia enabled mobile phones and provides continuous support in assignments and projects This fosters the very cause of continuous support and interaction in the educational institution and between students 100, expert instructors 12, local coordinators and teaching assistants throughout the duration of the course.

Expert instructor 12 prepares various sets of explorative assignments and projects 14. The assignments and projects are developed by the expert instructor 12 alone or he may take assistance of local coordinators, teaching assistants and experts in the field. In one embodiment of the invention, the assignment and projects are developed by the expert instructor alone. A set of explorative assignment and project 14 is given to the students 100 for practice. At the college or study centre, students 100 are provided access to computer equipments and those software licenses which are necessary for completion of the course. Every student is provided a unique user id with password and every student is given separate assignment and project. Students enrolled in the course are provided connectivity and accessibility to remote access labs at the administrative body 200 with all the required tools, to work on their coursework/subject.

Students 100 are provided full assistance and support to complete the assignments and projects through various means including, onsite, online and offline means. Students 100 are also provided continuous assistance from support staff 15 of administrative body 200 through online social networking methods including but not limited to messaging system like twitter, blogs, facebook etc 15. Students 100 are also provided assistance and support in understanding the subjects of lecture and completing the assignment and projects 14 through library and other online resources. Students are also given access to recorded webinar sessions 17 to again go through the lectures and understand the topics taught in the lecture. Each student is provided a unique user id and password to login the administrative body 200 website and access the recorded webinar sessions 17. All the webinar sessions are recorded and stored and in the local server 40 at administrative body 200 and the database is made available on the administrative body 200 website. Students 100 can select one or more recorded webinar sessions of their choice and access the same as per their requirements. Students 100 are also provided assistance from local co-ordinator/visiting faculty 18 who has expertise in both technical knowledge and skills in his subject. Students 100 can complete the assignments and projects 14 with the assistance of all or any of the online/offline supporting means like live interaction, online chatting and discussions, live and recorded webinars, online libraries, local co-ordinators, teaching assistants, visiting faculty and social media means like messaging, twitter and blogs. Students 100 create solution files in response to the course assignments and projects and transfer them online to the local server 40 of administrative body 200. Students can also submit their assignments and projects via offline and physical means like hard copies.

The expert instructor 12 accesses the student files from the local server of administrative body 200. Individual evaluation of each student is done on the basis of their assignment and projects. Student's progress is accessed by the expert instructor 12 based on their performance in these assignments and projects.

The expert instructor 12 posts the grade of each student separately into a file on the local server 40 which can be accessed only by the student or relevant personnel of the institution using the unique user id and password.

Skill matrix 21 of the students is tabulated to depict the level of achievement of the student in each subject before and after attending the course. Evaluation and assessment of each individual student is regularly done from beginning to the completion of the course. Skill matrix 21 is tabulated based on his/her performance in regular assessments and evaluation. The entire program of the education system disclosed in the invention is organized, supervised and coordinated by the administrative body 200.

This whole method of interactive study is established with a minimum technical equipments to cater the needs of the students efficiently and cost-effectively.

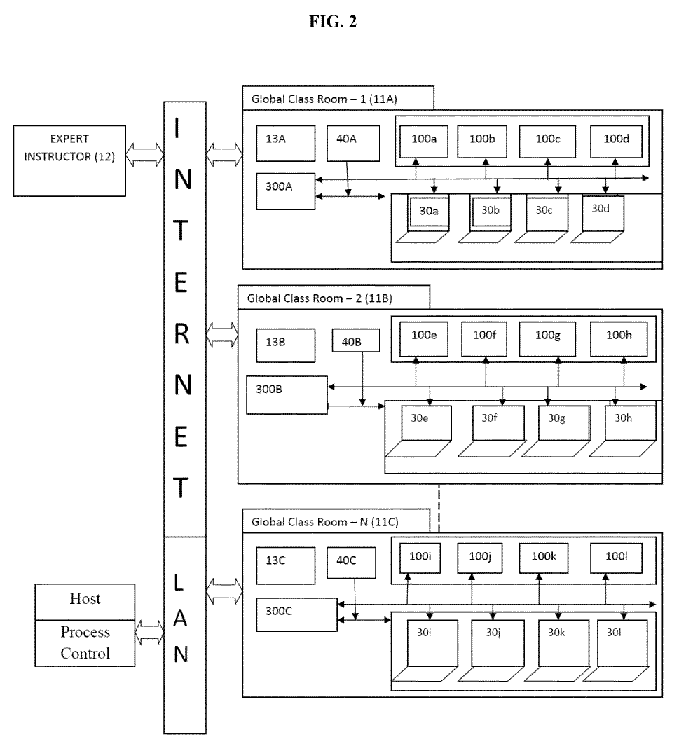

The system of explorative and experimental learning is embodied as shown in FIG. 2. The system has the ability to manage students at geographically apart locations from different streams of education which mainly comprises of atleast one administrative body 200, atleast one remotely located expert instructor 12, a plurality of Global Class Rooms (GCRs) 11 located in plurality of jurisdictions, atleast one interactive terminal 11, atleast one local co-coordinator 13A, 13B, 13C depending on the number of GCRs, atleast one student 100 in each GCR 11 and atleast one local server 40. It is basically characterized with resilience through redundant equipment and switch over process i.e. resilience at power failure, network failure and other political & natural distortions. At the time of unexpected distortions, the same lectures can be relayed and distributed to the student's place through their password protected web access. The expert instructor 12 from a remotely located place gives instructions and lectures that are transmitted through the internet connection to the plurality of Global Class Room 11 located in plurality of jurisdictions.

The GCR 11 which includes the interacting terminal mainly comprising of all the equipments, computers, servers and Audio Video distribution 300A, 300B and 300C bridges the received audio, video and other text files and display it in the projector screen. The student computers 30 (30a, 30b, 30c etc depending on the number of students 100a, 100b, 100c etc in the plurality of GCRs) are normally used during laboratory works and other interactive sessions. The relayed lecture is recorded and stored in the local server 40A, 40B, 40 C etc.

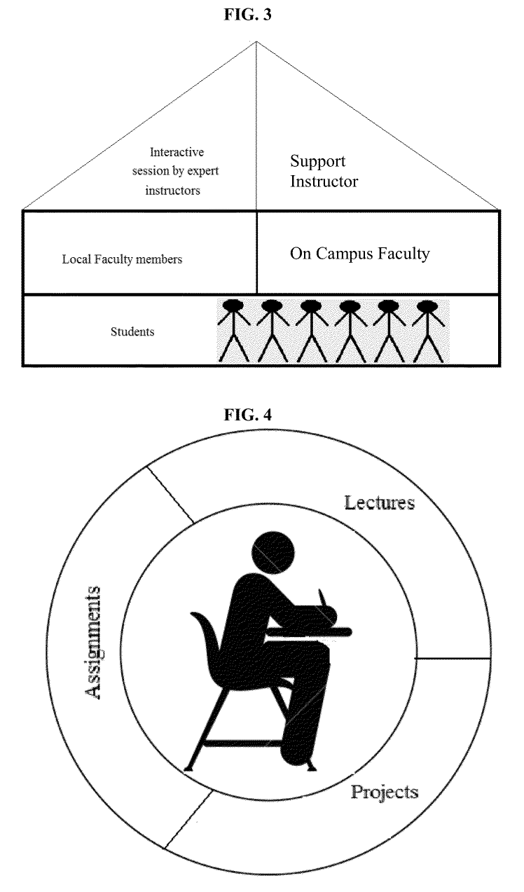

Referring to FIG. 3, the invention comprises a system and methods for the exchange of course content and related information between expert instructors 12 and non co-located students 100. The expert instructor 12 interacts with non co-located students 100 using the system and methods of the present invention and without any geographical limitation. The system comprises interactive sessions between expert instructor 12 and the students 100. Support instructors/teaching assistants of administrative body 200 assist the expert instructors in development of course curriculum and study materials and during interactive sessions with the students. Students 100 are also assisted in understanding the lectures, interacting with the expert instructors and completing the assignment and projects by local co-ordinators/local faculty members 18 and on-campus administrative body support instructors. Thereby, the invention provides a web of expert instructors, support instructors, local co-ordinators, local faculty members and on-campus faculties 18 and also provides a two-way interactive atmosphere to the students who can interact with the instructors online or offline or can access the recorded webinar sessions through multiple means of connectivity like webinar, worldwide web, internet, twitter, chat, facebook and any other electronic network 15.

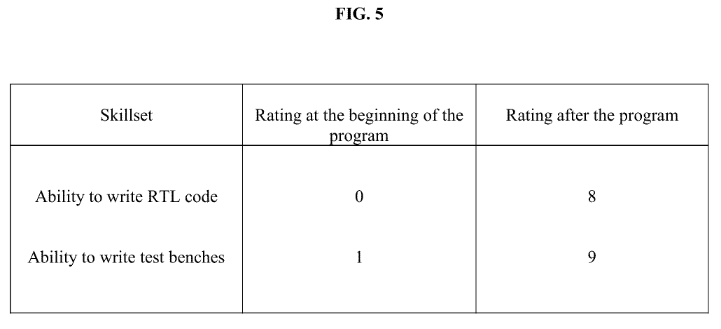

Referring to FIG. 4, the student 100 is provided with all the facilities and exposures required to obtain maximum knowledge regarding the subject through the course curriculum. The system of the invention comprises an interwoven matrix of lectures, assignments and projects with a two-way interactive atmosphere by multiple means. The lectures and interactive sessions are meant for teaching and skill development of the students whereas, assignments and projects are used to grade the student's performance in the course, except for analytical courses.

Referring to FIG. 5, a skill matrix 21 is designed to meet the industry's requirements. It is used to grade the students based on their performance in assignments and projects. The matrix 21 shows the level of achievement of the student in each subject before and after attending the course. The relevant statistics/metrics on student performance, tools' usage and coding quality etc are provided to the concerned college 201 by administrative body 200. The evaluation process may also result in grades, percentage, points etc depending on the academic regulations.

New course listings and/or updated applicable content notifications are provided to the colleges by administrative body 200. All the colleges and study centres 201 may be periodically visited by administrative body's technical as well as non-technical staff to monitor program quality and promote interaction between students. Expert guest lecturers are sent to the prospective colleges 201 from time to time by the administrative body 200. All technical and non technical issues are periodically reviewed and resolved by the administrative body 200.

1-42. (canceled)

43. An efficient and cost-effective interactive system for inculcating explorative and experimental learning skills with the ability to manage students at geographically apart locations from different streams of education, the interactive communication established through high bandwidth internet VOIP as primary channel, including an administrative body, atleast one remotely located expert instructor, a plurality of Global Class Rooms (GCRs) located in plurality of jurisdictions, atleast one interactive terminal, atleast one audio-video distributor bridge, atleast one local co-coordinator, atleast one student in each Global Class Room and atleast one local server, characterized with resilience through redundant equipment and switch over process during power and network failures, the said system comprising of:
a. Means to transmit the instructions and lectures from the expert instructor through the internet connection;
b. Means to capture and bridge the received signals between the internet connection and the Global Class Room;
c. Means to convert the user-specific and password protected signals to text, audio and video files;
d. Means to display the converted files on the projector screen and enable audio files audible through audio installation at the interaction terminal;
e. Means to record the webinar sessions; and
f. Means to store the recorded sessions in the database that is made available on the administrative body website.

44. The system as claimed in claim 43 wherein it further includes:
a. Means to transmit the course files including course lectures, textbooks, literature, assignments, projects and other course materials using offline networks;
b. Means to support the online and offline interaction between the expert instructor and students;
c. Means to support the students through internet, screen sharing, virtual network computing and multimedia enabled mobile phones;
d. Means to provide access to labs, libraries and other resources to work on their projects through a proper authentication given to the student;
e. Means to transfer the solution files in response to the project given to the students to the local server;
f. Means to evaluate each student based on their project work submitted and their skill matrix in each subject before and after attending the course based; and
g. Means to post grade for each student into the local server which can be accessed by proper authentication.

45. The system as claimed in claim 43 wherein means to transmit the instructions and lectures from the expert instructor through the internet connection further includes:
a. Means to survive power and network outages; and
b. Means to survive low bandwidth connections.

46. The system as in claim 43, wherein means to bridge is facilitated in compliance with the dimensions of the Global Class Room.

47. The system as claimed in claim 43, wherein the Global Class Room is managed by the administrative body 200.

48. The system as claimed in claim 43, wherein each Global Class Room comprises of interaction terminal, seating arrangements for the students with adjustable dimensions.

49. The system as claimed in claim 43, wherein the interactive terminal comprises of equipped devices including computers 30, Audio-Video Distributor, video projector, projector screens, webinar and VOIP internet tools, audio installations, back up teleconference, power supply and related accessories to bridge the distribution of the instructions and lectures to the students in the Global Class Room.

50. The system as claimed in claim 44, wherein said offline communication further includes means to distribute and transmit the lectures and instruction offline through social networking, messaging, mails and other blogs.

51. The system as claimed in claim 43, wherein said expert instructor is a well referenced, experienced, knowledgeable, valuable and expert person with cutting edge research and practice in his/her subject domain selected from science, arts, medicine, engineering, technology, economics, culture, law, management, social studies, humanities and general studies.

52. The system as claimed in claim 43, wherein the local server located at administrative body includes recorded and stored webinars, lectures, instructions, guidelines, curriculums, assignments, projects, comments, messages, twitters, blogs, solution files of assignments and projects, assessment sheets, evaluation sheets, grades and tabulated skill matrix.

53. A system as claimed in claim 43, wherein the local coordinator selected from a group of local faculty members having knowledge, trained, skilled in the subject domain and professionally qualified depending on the respective jurisdiction, is a contact point of administrative body in the college or study center and manages lecture sessions, monitors and controls proper functioning of the audio-video equipments, assists the students during the lecture and liaison between the college or study centre and administrative body.

54. An efficient and cost-effective interactive method for inculcating explorative and experimental learning skills with the ability to manage students at geographically apart locations from different streams of education, the interactive communication established through high bandwidth internet VOIP as primary channel, including an administrative body, atleast one remotely located expert instructor, a plurality of Global Class Rooms (GCRs) located in plurality of jurisdictions, atleast one interactive terminal, atleast one audio-video distributor bridge, atleast one local co-coordinator, atleast one student in each Global Class Room and atleast one local server, characterized with resilience through redundant equipment and switch over process during power and network failures, the said method comprising the steps of:
a. Transmitting the instructions and lectures from the expert instructor through the internet connection;
b. Capturing and bridging the received signals between the internet connection and the Global Class Room;
c. Converting the user-specific and password protected signals to text, audio and video files;
d. Displaying the converted files on the projector screen and enable audio files audible through audio installation at the interaction terminal;
e. Recording the webinar sessions; and
f. Storing the recorded sessions in the database that is made available on the administrative body website.

55. The method as claimed in claim 54 wherein it further includes the steps of:
a. Transmitting the course files including course lectures, textbooks, literature, assignments, projects and other course materials using offline networks;
b. Supporting the online and offline interaction between the expert instructor and students;
c. Supporting the students through internet, screen sharing, virtual network computing and multimedia enabled mobile phones;
d. Providing access to labs, libraries and other resources to work on their projects through a proper authentication given to the student;
e. Transferring the solution files in response to the project given to the students to the local server;
f. Evaluating each student based on their project work submitted and their skill matrix in each subject before and after attending the course based; and
g. Posting grade for each student into the local server which can be accessed by proper authentication.

56. The method as claimed in claim 54 wherein transmitting the instructions and lectures from the expert instructor through the internet connection further includes the steps of:
a. Surviving power and network outages; and
b. Surviving low bandwidth connections.

57. The method as claimed in claim 54, wherein the bridging is tuned to the dimensions of the Global Class Room.

58. The method as claimed in claim 54, wherein communicating offline further includes distributing and transmitting the lectures and instructions through social networking, messaging, mails and other blogs.

59. A method as claimed in claim 54, wherein a two way interactive atmosphere is established between students and expert instructor through local coordinators, on-campus local faculty members, online communication means and offline communication means to interact with expert instructor, understand the lecture contents, discuss the subject, complete the assignment and project, and enhance the knowledge and industrial skills in the students.
